(19) United States
(12) Patent Application Publication
(10) Pub. No.: US 2026/0201994 A1
(43) Pub. Date: Jul. 16, 2026

(54) A COUPLING ASSEMBLY

(71) Applicant: Torsion Tool Company AS, STAVANGER (NO)

(72) Inventor: Olav OLSEN, STAVANGER (NO)

(21) Appl. No.: 19/137,598

(22) PCT Filed: Dec. 12, 2023
(86) PCT No.: PCT/NO2023/060121

§ 371 Date: Jun. 10, 2025

(30) Foreign Application Priority Data
Dec. 13, 2022 (NO) 20221334

(51) Int. Cl. F16L 37/14; E21B 17/046

(52) U.S. Cl. CPC F16L 37/14; E21B 17/0465

(57) ABSTRACT

A coupling assembly for elongated elements (1, 2) comprises a pin member (5) having an outward-facing pin surface (12) and a box member (6) having an inward-facing box surface (13). The assembly comprises one or more elongated flexible locking member (30). The pin member (5) is provided with one or more first circular and circumferential groove (31), and the box member (6) is provided with one or more corresponding second circular and circumferential groove (32). When the pin-and-box connection is made up, a set of first groove (31) and second groove (32) are aligned and the grooves form a circular and circumferential channel (41) shaped and dimensioned for receiving the elongated flexible locking member (30).

### FIELD OF THE INVENTION

The invention relates to the field of couplings for connecting elongated elements, such as pipes, tubes, rods, shafts or axles. More specifically, the invention concerns a coupling assembly as specified in the preamble of claim 1.

### BACKGROUND OF THE INVENTION

Pipe sections or tubular sections used for drilling deep wells in e.g. oil or gas reservoirs or geothermal formations, utilize long sections of drill pipe, well casing or tubing that traditionally have a tapered, exteriorly-threaded male end called a pin member. In use, the pin members are threaded into corresponding couplings, collars or integral female pipe sections; their threaded ends are called a box member. These box members have an interiorly-threaded tapered thread corresponding to their respective pin members.

A dominant type of pin-box connection has been the American Petroleum Institute (API) threaded and coupled connection that achieves its assembly with threads and torque shoulders. These tapered connections provide increasing bearing stresses to the seal between the pin member and box member with increasing engagement produced by rotational torque. Hydraulic tongs, often referred to as an “iron roughneck”, or manually operated tongs are normally used to make up connections between drill pipe, while so-called “casing tongs” are used to make up casing and production pipe (or liner).

As the well depths and lengths (as well as the number of long horizontal wells and directional wells) have increased, the drilling and production environment has become more demanding. For example, a well of 6000 meters may require as much as 7000 connections and disconnections of pipe, with varying torque. The threaded pin-box connections need to meet rigorous demands regarding pressure loss across the connection, tension/compression resistance, higher torque, and resistance to internal and external pressure. The threaded connections developed to meet these demands are referred to as “premium” connections and “double-shoulder connection” (DSC).

The prior art includes U.S. Pat. No. 3,923,324 A, which describes a drill collar for a rotary drill string, including a threadless drill collar body having pins being frictionally mounted by means of a shrink-fit on opposite ends of the body, to corresponding boxes of opposite subs. The frictional connection between the matching conical surfaces between conical pins of the drill collar body, and the corresponding subs, respectively, is accomplished as by the application of pressure fluid between the adjacent contacting surfaces, while simultaneously applying an axial force, as by fluid or hydraulic pressure, to push or force the box shaped portion of each sub onto its companion conical pin of the drill collar body, until such box shaped member abuts a shoulder adjacent the connection of the conical pins with the main drill collar body. A port is provided in the box shaped portions of each sub for introduction of gaseous or hydraulic fluid pressure into the space between the box and pin, for laterally expanding the sub box during shrink-fitting thereof onto the corresponding pin.

The prior art also includes GB 2 113 335 A, GB 2 180 312 A, GB 2 113 334 A, and U.S. Pat. No. 4,561,683 A.

An example of the prior art is illustrated in FIGS. 1 and 2. A coupling assembly comprises a first mating member 5 and a second mating member 6, the first mating member being a pin member 5 which forms an end portion of a first pipe 1 having an internal bore 3. The second mating member is a box member 6 which forms an end portion of a second pipe 2 having an internal bore 4. Only a part of the first and second pipes 1,2 are shown. The pipes 1,2 may for example be drill pipes, liners, casing joints or other tubular elements configured for rotational movement and for conveying a fluid. In fact, although not illustrated, the pipes may be replaced by other elongated elements such as shafts and axles.

The pin member 5 comprises a first mating surface 12, hereinafter also referred to as a pin surface 12, here in the shape of a frusto-conical surface facing outwards with respect to a central axis. The pin surface ends at a pin shoulder 14. The box member 6 comprises a second mating surface 13, hereinafter also referred to as a box surface 13, here in the shape of a frusto-conical surface facing inwards with respect to the central axis. The box surface ends at an internal box shoulder 16. Such pin-and-box shapes are well known in the art. Seals (not shown) may be arranged at the pin shoulder 14 and the pin free end 15, or (more common) at the pin free end 15 and the box inner shoulder 16. The seals may be integrated (as profiles in the pin and/or box) or may be removable, and may comprise materials such as elastomers and/or metals. It should be understood, however, that the pin-and-box coupling may also be used without seals.

In the embodiment illustrated in FIGS. 1 and 2, the pin surface 12 and box surface 13 are plain surfaces, without helical threads or other pronounced protrusions configured for mating engagement. The pin and box surfaces are thus generally smooth, but may comprise a textured finish (roughness) of a certain topography in order to augment static friction (and hence adherence) between the pin and box when connected. Such topography may be obtained by friction coating (by for example nickel coating with diamonds) or by increasing surface roughness through sandblasting or similar. Although not illustrated, the pin and/or box surfaces, or portions of these surfaces, may be furnished with serrations in order to increase the torque capacity of the connected coupling.

Arranged in the external wall of the box member 6 is an opening (a port) 9a which is the outward opening of a bore 9 extending through the box member wall and into the box member interior, penetrating the box surface 13 in an inward opening 9b. The bore 9 therefore provides a fluid access channel into the box. It should be understood that although only one bore 9 is shown in the figures, a practical embodiment may comprise several bores.

Seals 7, 8 are arranged in the region of the pin shoulder and pin free end, respectively. However, the seals may be arranged on the box instead, and a combination of the two arrangements is conceivable. The seals serve to form a frusto-conical annular cavity during the initial mating, to contain injected fluid. FIG. 1 also shows how a pressurized fluid reservoir 10 is connected to the bore 9 via a conduit 10a. The reservoir 10 preferably contains a liquid, such as (but not necessarily limited to) water, which may be injected under pressure into the box member 6, controlled via the control valve 11. FIG. 1 also illustrates an alternative configuration in which the reservoir 10 is connected to a bore 9′ which extends through the pin member 5 body, and where the bore 9′ penetrates the pin surface 12 with the opening 9b. The effect of this configuration is equivalent to the configuration in which the bore 9 extends through the box member 5 wall inasmuch as both bore configuration deposit the injected fluid at more or less the same location during a mating operation. However, connecting the reservoir 10 to the bore 9′ extending through the pin member 5 body may have certain operational advantages.

In FIG. 2, the pin member 5 and box member 6 have been moved together in an axial movement (i.e. no rotation necessary), a pressurized hydraulic liquid (e.g. water) is injected from the reservoir 10 through the bore 9 (or bore 9′) when the seal 7 and the seal 8 have created a cavity V between the pin surface 12 and the box surface 13. This cavity V, which essentially is an annular, frusto-conical, cavity, is very small compared to the dimensions of the pin and box surfaces and therefore only appears as a solid black line in FIG. 7. The fluid pressure inside the cavity V causes elastic deformation in the pin member and box member, such that the box member wall expands radially (see arrows “E” in FIG. 2) and the pin member is compressed radially (see arrows “C” in FIG. 2). This deformation allows the pin member to be inserted an additional distance d into the box member. At the stage where the box free end meets the shoulder on the pin member, the fluid pressure is released, causing the pin and box members to resume their original shape and thus forming a tight and high-tension connection.

The prior art also includes WO 2018/143819 A1, by the present inventor and incorporated here as a reference in its entirety, disclosing a coupling assembly for elongated elements comprising a pin member and a box member. The pin and box members have complementary and respective frusto-conical pin and box mating surfaces. A bore has as a first opening a port configured for connection to an injection fluid reservoir and a second opening penetrating the pin mating surface or the box mating surface. The surfaces may be plain surfaces without helical threads or other pronounced protrusions configured for mating engagement, but comprise a textured finish in order to augment static friction between the surfaces when the surfaces are connected. The pin surface may comprise a plurality of protruding portions separated by recessed portions, and the box surface may also comprise a plurality of protruding portions separated by recessed portions. Each pin protruding portion is shaped and dimensioned to fit into a designated box recessed portion, and each box protruding portion is shaped and dimensioned to fit into a designated pin recessed portion.

The prior art also includes US 6 981 547 B2, which discloses an expandable connection for a wellbore tubular, comprising a first tubular member having a variable pitched groove formed on an inside surface thereof and a second tubular member having a variable pitched groove formed on an outside surface thereof, wherein the tubular members are mateable to form a variable pitched continuous recess through the variable pitched grooves; and an aperture formed in a wall of the first tubular, the aperture provides a pathway for inserting a wire into the variable pitched continuous recess, whereby the wire rotationally and axially fixes the first tubular member to the second tubular member.

The prior documents U.S. Pat. No. 4,491,351 A, US 2015/0292274 A1, U.S. Pat. No. 6,913,293 B1, and US 2003/0122373 A1 all describe connectors having helical (spiral-like) grooves and/or channels.

The prior art couplings are predominantly concerned with handling either torque or compression/tension. There is a need for an improved coupling, that is more reliable and efficient, and which offers more operational advantages over the prior art.

### SUMMARY OF THE INVENTION

The invention is set forth and characterized in the main claim, while the dependent claims describe other characteristics of the invention.

It is therefore provided a coupling assembly for elongated elements, comprising a pin member having an outward-facing pin surface, and a box member having an inward-facing box surface; said pin surface and box surface configured for mating engagement, characterized by
one or more elongated flexible locking members and in that
the pin member is provided with at least one or more first circular and circumferential, non-helical, groove and
the box member is provided with a corresponding at least one or more second circular and circumferential, non-helical, groove and,
the box member is provided with at least one insertion port, aligned with the at least one second groove,
whereby, when the pin-and-box connection is made up, a first groove and a corresponding second groove are aligned and form a circular, non-helical, and
circumferential channel shaped and dimensioned for receiving the elongated flexible locking member.

In one embodiment, the circular grooves are arranged perpendicularly to a longitudinal axis of the box and pin. In one embodiment, the elongated flexible locking member material has a higher strength than that of the box and pin material. In one embodiment, the elongated flexible locking member is a wire or flexible rod.

In one embodiment, the coupling assembly comprises an at least one bore having as a first opening a port configured for connection to an injection fluid reservoir and a second opening penetrating the pin surface or the box surface, whereby a fluid may be injected into a cavity formed between at least a portion of an outer pin surface and a corresponding inner box surface portion.

In one embodiment, the pin member comprises an external circumferential seal groove and the box member comprises an internal circumferential seal groove, and wherein the grooves are configured and arranged for alignment when the pin-and-box connection is made up, and for receiving a seal. In one embodiment, the seal grooves are arranged such that they isolate the cavity from the channel formed by the at least one first groove and the at least one second groove when the pin-and-box connection is made up.

In one embodiment, at least a first cavity is arranged on one side of the at least one channel and at least a second cavity is arranged on the other side of the at least one channel. The first cavity and the second cavity are defined by respective portions of the pin outer surface and the box inner surface, and respective sets of seals.

The locking member may comprise a fastener element, and the box member may comprise a slot in the vicinity of the insertion port, the slot configured for receiving a fastener element. The locking member length may correspond to the channel circumference.

In one embodiment, the pin surface comprises a plurality of pin protruding portions separated by pin recessed portions, and the box surface comprises a plurality of box protruding portions separated by box recessed portions; and wherein a pin protruding portion is shaped and dimensioned to fit into a designated box recessed portion, and wherein a box protruding portion is shaped and dimensioned to fit into a designated pin recessed portion.

In one embodiment, the elongated flexible locking member comprises an axial bore, whereby a fluid may be injected into the cavity or cavities formed between the pin and box surfaces.

The invented coupling assembly may be connected and disconnected without rotational motion (as is necessary with a threaded connection), only axial motion and application of hydraulic pressure are required. The pin and box surfaces may be smooth or comprise complementary stepped profiles (protruding and recessed portions). Adhesion between the surfaces may be augmented by friction coating (e.g. electrode-less nickel coating with diamonds or similar), a serrated surface, particles in the injected fluid, “double-helix engravement” (fluid pressure distribution and friction particles distribution), separate friction sleeves, or/and by increasing surface roughness (by e.g. sandblasting or similar).

Besides the bias created by hydraulics and steel elastic properties, the friction factor between the pin and box will contribute to the connection. The hydraulic fluid may be water or glue with or without a corrosion inhibitor, with or without particles, together with a surface structure or/and a separate friction shim, or/and an applied friction increasing coating, seeking the highest possible friction factor. The elongated flexible locking member prevents “creepage”, or “microslip”, i.e. a tendency for the pin to be forced out of the box when the rotating pin-and-box connection is subjected to tension and alternating bending moments. The invented coupling exhibits improved performance over the prior art, in that it can handle combined torque, tension and compression, and internal and external fluid pressures.

The invented coupling assembly may be useful for connecting any elongated elements that may rotate and transfer torque; such as pipes, propeller shafts, axles, as well as various tubulars such as drill pipe (drill string) and casing for casing-drilling. The invented coupling assembly transfers torque equally well in both rotational directions (as opposed a prior art threaded coupling). This “bidirectional” torque capability is particularly useful is a drill pipe is jammed and it is necessary to counter-rotate to release the drill bit or other downhole tools. The coupling assembly may also be useful for non-rotating elongated elements, such as rods, different process pipe lines, borehole casings and liners.

The invention is suitable with any materials commonly used in pipes, propulsion shafts, axles, drill pipe (drill string), drilling risers, rods, borehole casings, liners, etc., such as stainless steel. However, the invented coupling also lends itself to the use of various steel grades (e.g. 100 ksi box and 130 ksi pin), light-weight materials, such as fibre-reinforced composites, titanium, aluminum and similar alloys. That is, both the coupling and the associated elongated elements may be made of such materials (or in combination). This will allow for a significant weight reduction of e.g. drill strings, compared to the steel drill strings of the prior art. The invention also comprises a combination in which the pin and box are of different materials.

### BRIEF DESCRIPTION OF THE DRAWINGS

These and other characteristics of the invention will become clear from the following description of embodiments, given as non-restrictive examples, with reference to the attached schematic drawings, wherein:

FIG. 1 is a schematic sectional view of a coupling assembly according to the prior art, in a plane along a longitudinal central axis, in a disconnected state;

FIG. 2 corresponds to FIG. 1, and illustrates a method of connecting the pin member and the box member;

FIG. 3a is a perspective view of an embodiment of the invention, illustrating a pin and box and a locking member in a disconnected state, and FIGS. 3b and 3c are enlarged views of areas C and D, respectively, in FIG. 3a;

FIG. 4 is a sectional schematic view of the coupling assembly shown in FIG. 3a, in a plane along the longitudinal central axis x-x, in a disconnected state;

FIG. 5a is a transparent side view of the embodiment illustrated in FIG. 3a, in a mated and locked state, and FIG. 5b is an enlarged view of area E in FIG. 5a;

FIG. 6a is a close-up and transparent side view of the embodiment illustrated in FIG. 5a, in a mated and locked state;

FIGS. 6b and 6c are enlarged views of area F in FIG. 6a, where the locking member is removed and the pin and box have been separated for clarity of illustration; in 5 FIGS. 7 to 10 are perspective views of the embodiment illustrated in FIGS. 3a-c, and illustrate different steps in a mating (or, if seen in the reverse order: a disconnection) procedure;

FIG. 11 is a close-up and transparent perspective view of the embodiment illustrated in FIG. 10, in a mated and locked state;

FIG. 12 is a perspective view of a further embodiment of the invention, illustrating i.a. a pressure fitting (in an exploded view);

FIGS. 13 and 14 are perspective views of the embodiment illustrated in FIG. 12, and illustrate i.a. the insertion (or, if seen in the reverse order: removal) of the locking member through the pressure fitting;

FIGS. 15-19 illustrate another embodiment of the invention, comprising a plurality of channels and corresponding elongated locking members;

FIGS. 20-22 illustrate another embodiment of the invention, comprising two cavities, one on each side of the plurality of channels; and

FIG. 23 is an enlarged view of area G in FIG. 20, and illustrates an embodiment of the elongated locking member having an internal fluid channel.

### DETAILED DESCRIPTION OF EMBODIMENTS

The following description will use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

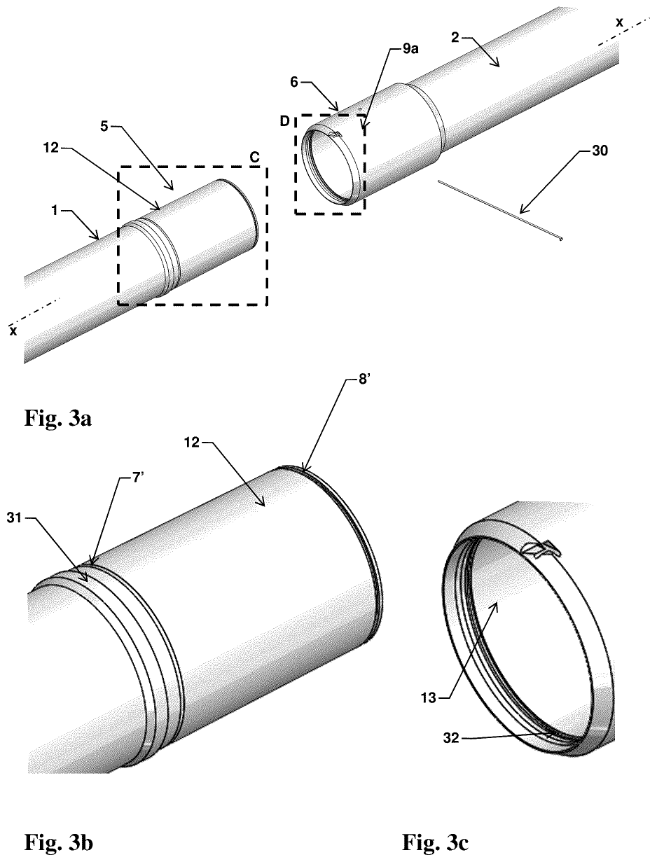

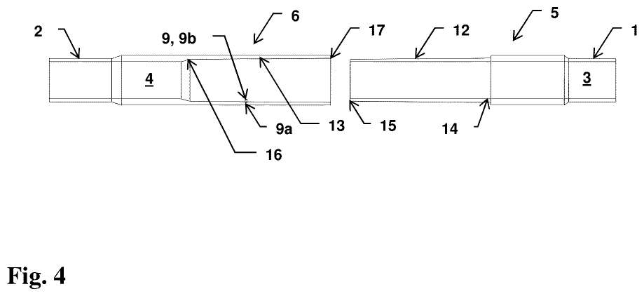

Referring initially to FIGS. 3a to 3c and to FIG. 4, the invented coupling assembly comprises a first mating member 5 and a second mating member 6. In the illustrated embodiment, the first mating member is a pin member 5 which forms an end portion of a first pipe 1 having an internal bore 3. The second mating member is a box member 6 which forms an end portion of a second pipe 2 having an internal bore 4. It should be understood that only a part of the first and second pipes 1,2 are shown, and the skilled person will understand that these pipes may be several meters long. The pipes 1,2 may for example be drill pipes, liners, casing joints or other tubular elements configured for rotational movement and for conveying a fluid. In fact, although not illustrated, the pipes may be replaced by other elongated elements such as shafts and axles. The invention shall therefore not be limited to a coupling assembly for tubular elements, but be applicable to a coupling assembly for any elongated elements interconnected by a pin-and-box connection. Therefore, this description will hereinafter refer to first and second elongated elements 1,2.

The pin member 5 comprises a first mating surface 12, hereinafter also referred to as a pin surface 12, here in the shape of a frusto-conical surface facing outwards with respect to the central axis x-x. The pin surface ends at a pin shoulder 14.

The box member 6 comprises a second mating surface 13, hereinafter also referred to as a box surface 13, here in the shape of a frusto-conical surface facing inwards with respect to the central axis x-x. The box surface ends at an internal box shoulder 16.

Such pin-and-box shapes are per se well known in the art, and need therefore not be described in further detail here. Seals (not shown) may be arranged at the pin shoulder 14 and the pin free end 15, or (more common) at the pin free end 15 and the box internal shoulder 16. The seals may be integrated (as profiles in the pin and/or box) or may be removable, and may comprise materials such as elastomers and/or metals. It should be understood, however, that the pin-and-box coupling may also be used without such seals.

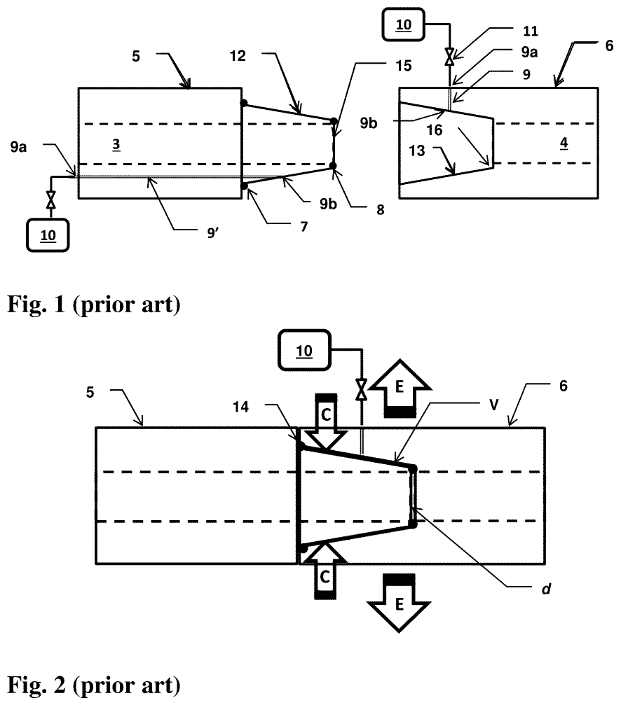

In the embodiment illustrated in FIGS. 1-5b, the pin surface 12 and box surface 13 are plain surfaces, without helical threads or other pronounced protrusions configured for mating engagement.

The pin and box surfaces are thus generally smooth, but may comprise a textured finish (roughness) of a certain topography in order to augment static friction (and hence adherence) between the pin and box when connected. Such topography may be obtained by friction coating (by for example nickel coating with diamonds) or by increasing surface roughness through sandblasting or similar. Although not illustrated, the pin and/or box surfaces, or portions of these surfaces, may be furnished with serrations in order to increase the torque capacity of the connected coupling.

Although not illustrated, another adherence-enhancing topography may be such that the frusto-conical pin surface is provided with grooves, extending in a double-helical formation. This is described in more detail in the above-mentioned WO 2018/143819 A1, by the present inventor. The grooves are preferably quite shallow in relation to the dimensions of the pin and box, for example a groove depth be on the order of one tenth of a millimeter for a pin having an outer diameter (OD) of 120 mm. A double helix may also be formed in the box surface, either in lieu of the double-helical formation in the pin or as a supplement to it. The helical grooves serve two functions, by providing a) fluid distribution channels during mating and b) distribute friction-enhancing fluid with particles.

Although not illustrated, the pin surface 12 and box surface 13 may each comprise radially protruded portions and radially recessed portions. More specifically, the pin surface 12 may comprise successive (in the axial direction) circular and radially protruding portions (“pin rings”) and circular and radially recessed portions (“pin recesses”). Correspondingly, the box surface may comprise successive (in the axial direction) circular and radially protruding portions (“box rings”) and circular and radially recessed portions (“box recesses”). The axial widths of the pin rings and pin recesses decrease in the direction towards the pin free end; that is, the widths are greater in the region of the pin shoulder than in the region of the pin free end. Conversely, the axial widths of the box rings and box recesses increase in the direction towards the box free end; that is, the widths are smaller in the region of the box inner shoulder than in the region of the box free end (opening). This is described in more detail in WO 2018/143819 A1, by the present inventor, in which the key-and-lock functionality is referred to as the “Key-Loc” concept. A central feature of this concept is that all ring-and-recess pairs must be aligned before the initial mating is complete.

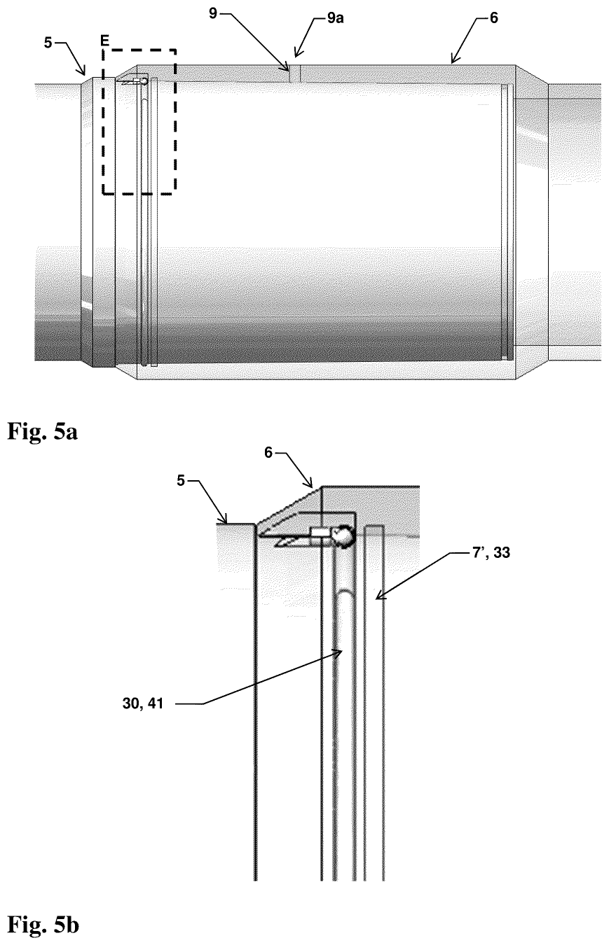

Referring now to FIG. 5a,b and 6a-c, the pin member 5 is provided with a first circular and circumferential groove 31, and the box member 6 is provided with a second circular and circumferential groove 32. In the illustrated embodiment, the circular grooves 31, 32 are non-helical; that is, they are arranged perpendicularly to the longitudinal axis of the box and pin, i.e. with no pitch. Reference numbers 33 and 7′ denote seal grooves on the box 6 and pin 5, respectively (a seal is not illustrated). Reference number 38 points to a chamfer at the box 6 free end. This chamfer is useful during the assembly procedure, as the box free end (tip) does not deform (elastically) as much as the main portion of the box during the liquid injection.

When the pin-and-box connection is made up, by applying the fluid pressure as described above, the first groove 31 and the second groove 32 are aligned and form a circular and circumferential and non-helical channel 41. This channel is shaped and dimensioned for receiving an elongated flexible locking member 30, preferably in the form of a locking wire or flexible rod 30 (see e.g. FIGS. 5b, 6a and 7). In one embodiment, the locking member material has a higher strength than that of the box and pin material. It will be understood from the above and from the figures that the seal grooves 7′, 33 are arranged such that they isolate the cavity V from the channel 41 when the pin-and-box connection is made up.

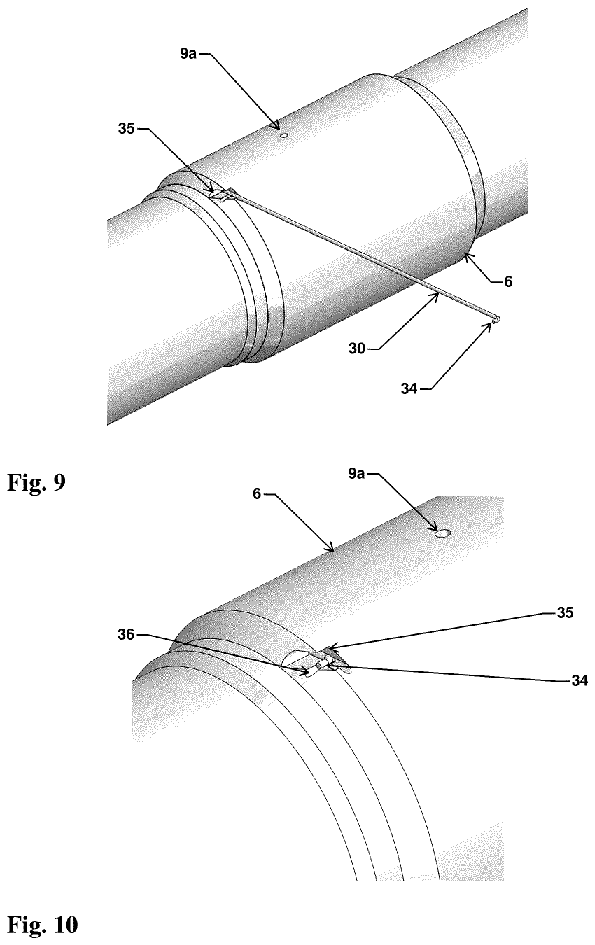

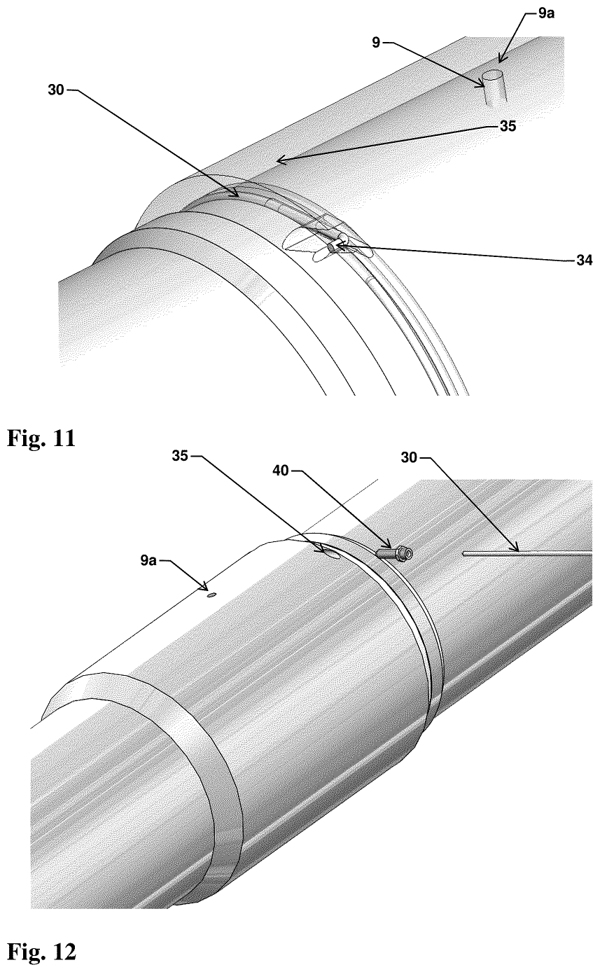

The assembly (mating, stabbing) procedure is performed generally by the same procedure as for the embodiments described above. In FIG. 7, the pin 5 has been inserted into the box 6 until mechanical friction (due to interference) prevents further mating. In FIG. 8, fluid (e.g. water) has been injected into the connection via fluid port 9a, as described above, whereby the box 6 is expanded radially and the pin 5 is compressed radially, and the pin and box are moved into a fully mated state (i.e. tip abuts shoulder, as described above). At this stage of the assembly procedure, the locking member 30 is inserted into an insertion port 35 on the box 6 until a fastener element 34 is lodged in a complementary-shaped slot 36 in the vicinity of the insertion port 35, see FIGS. 9 and 10. The insertion port 35 is aligned with the channel 41 formed by the first and second grooves 31, 32. A further close-up view is provided by FIG. 11. If the pin-and-box connection, when made up and in use, will be subjected to rotation, the grooves and insertion port are oriented towards (opposite to) the direction of rotation, in order to prevent the locking member from being dislodged during rotation.

At this stage of the assembly process, the liquid is allowed to bleed off through the fluid port 9a, as described above, whereupon the box 6 is allowed to contract radially and the pin 5 is allowed to expand radially, and the locking member 30 is compressed between the pin and box. With the locking member 30 in place, the pin-and-box connection tensile strength is improved, while the torsion strength is maintained.

Breaking the pin-and-box connection is performed using a reversed procedure.

It will be understood that the locking member 30 length preferably corresponds to the channel circumference, whereby the locking member fills substantially the entire length of the channel. As an alternative embodiment, the locking member thickness (e.g. diameter) may be dimensioned such that the locking member may be inserted (and removed) even when the pin-and-box connection is fully made up, i.e. after the liquid has been bled off.

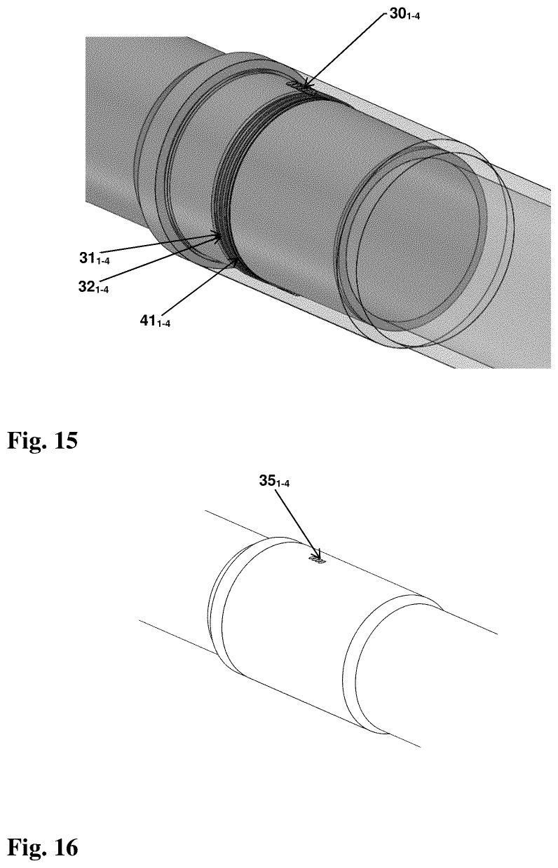

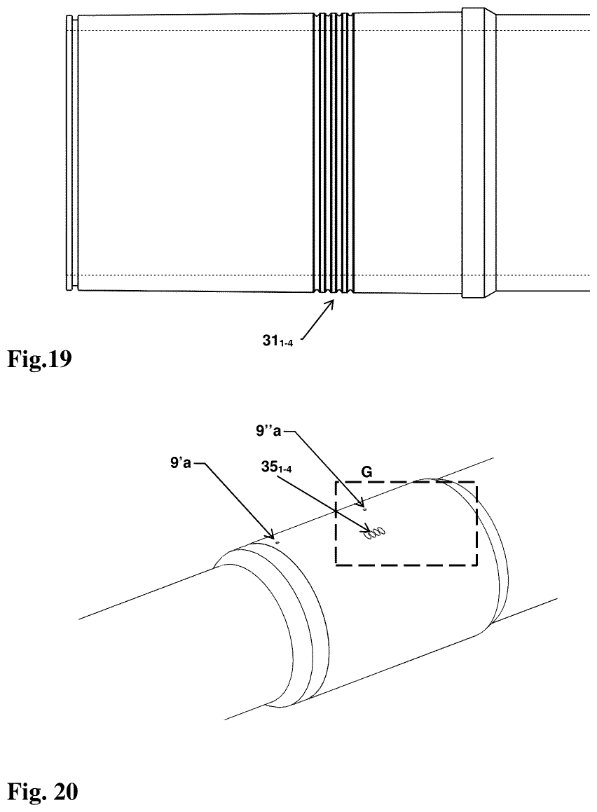

Although only one locking member 30 and one channel 41 (i.e. aligned grooves 31, 32) have been illustrated in the figures referred to above, it should be understood that several such grooves may be arranged along the axial length of the pin and box, for forming corresponding channels for receiving respective locking members. This is illustrated in FIGS. 15-19, wherein the pin and box are provided with four respective grooves 31₁₋₄, 32₁₋₄, the box is provided with four separate injection ports 35₁₋₄ and four elongated locking members 30₁₋₄ are configured for insertion into respective channels 41₁₋₄ formed by a pair of aligned grooves 31, 32. It should be understood that the pin and box may comprise fewer or more such grooves.

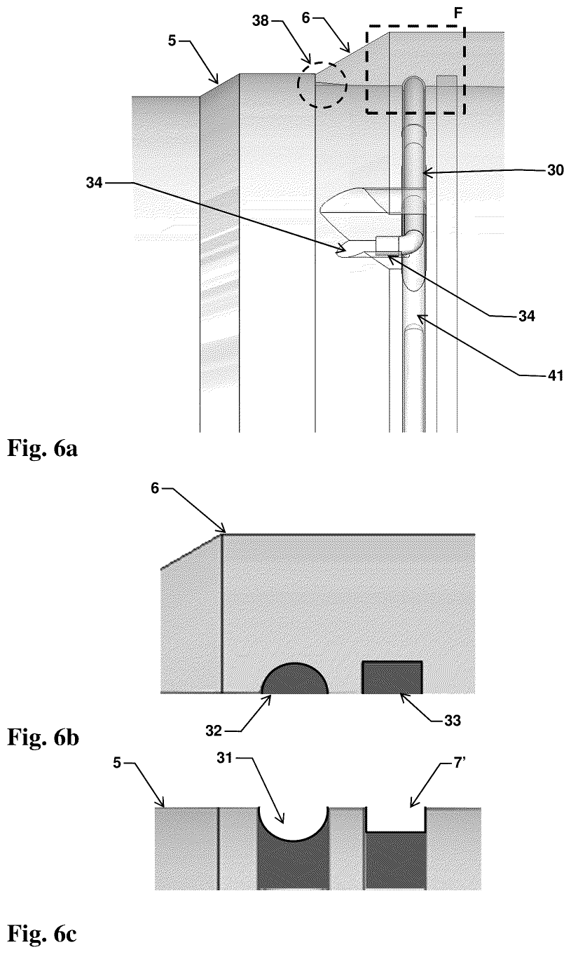

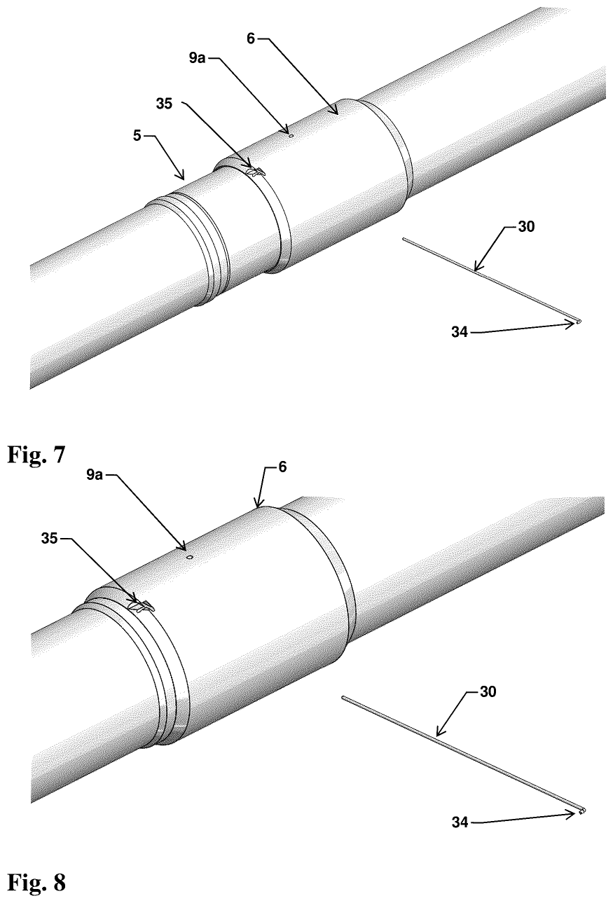

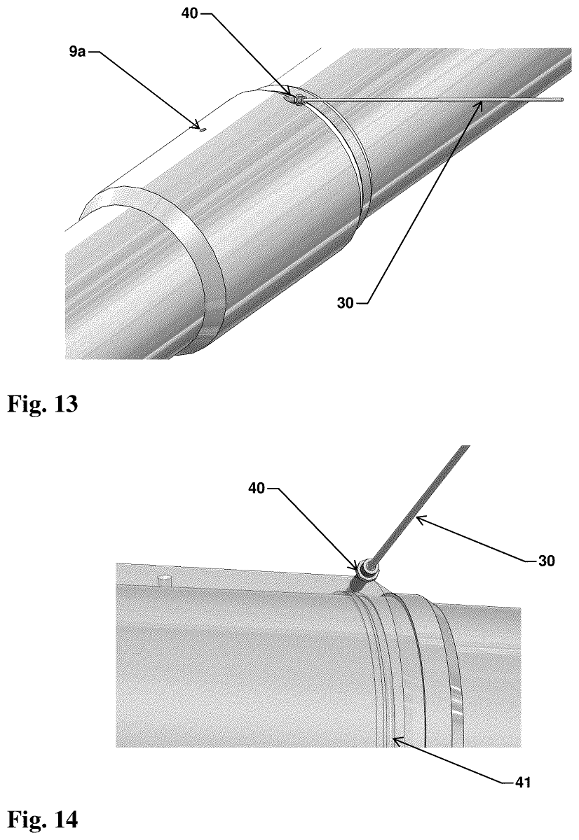

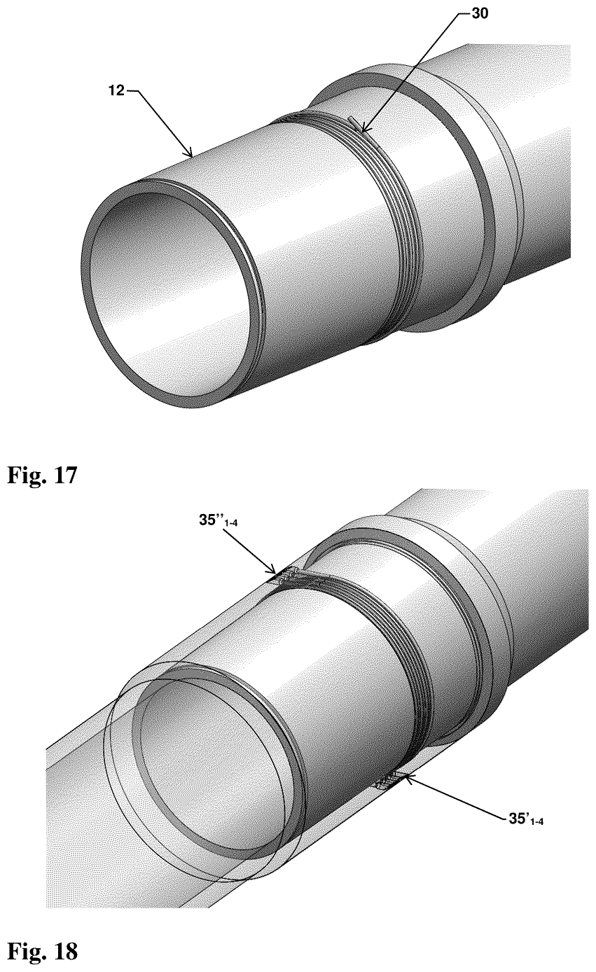

FIG. 18 illustrates a variant in which the box is provided with two sets of four injection ports 35′, 35″, arranged on diametrically opposite sides of the box, whereby respective elongated locking members 30 may be inserted in each injection port. In this variant of the invention, the length of the locking members 30 are half of the length of the locking member described above, i.e. about half the length of the channel formed by the aligned grooves. (Although not illustrated in FIGS. 15-20, it should be understood that also this embodiment comprises fluid ports as described above.) A further variant is illustrated in FIGS. 12-14. Here, a pressure fitting 40 is arranged in the insertion port 35. The pressure fitting maintains the pressure inside the cavity formed between the pin-and-box connection and allows the locking member 30 to be inserted into the above-mentioned channel when the cavity V (see FIG. 2) is pressurized by inserted fluid. In this variant, the channel 41 (which receives the locking member) is arranged in the pressurised zone, that is: the seal grooves 7′, 33 and the grooves 31, 32 (that form the channel 41) are arranged on opposite sides compared to the configuration illustrated in FIG. 6c. Although not illustrated, the locking member 30 may be forced into the channel via a fluid pressure in a pipe or tube, or by a mechanical device.

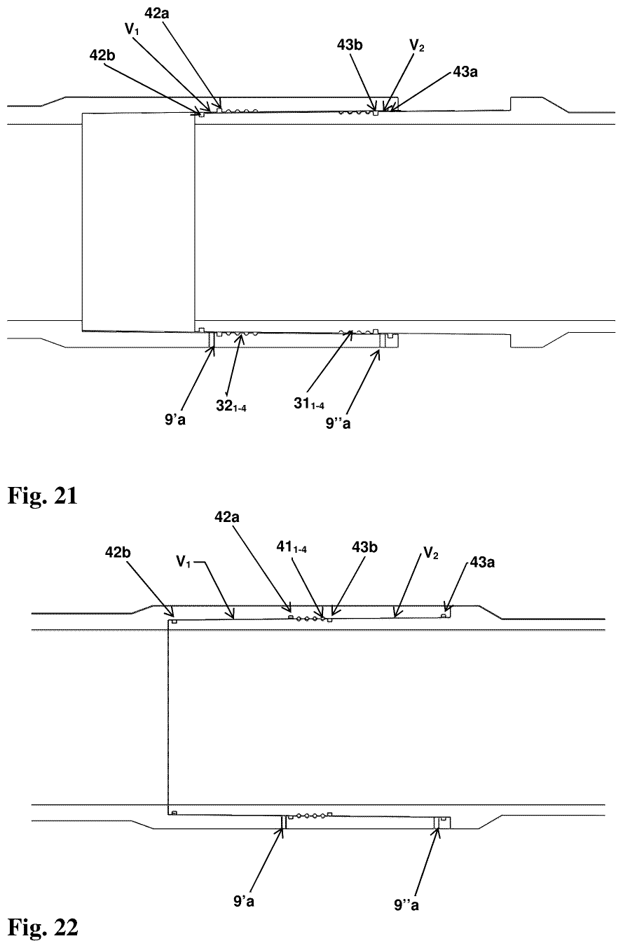

FIGS. 20-22 illustrates an embodiment having two cavities V₁, V₂, arranged on each side of the channels 41₁₋₄. Each cavity is accessible via respective fluid channels and ports 9′a, 9″a. FIG. 20 illustrates a variant having four insertion ports 35, but this embodiment may have fewer or more insertion ports (and channels 41). FIG. 21 illustrates an initial stage of a mating process, in which a first cavity V₁ is defined by a first set of seals 42a,b, and a second cavity V₂ is defined by a second set of seals 43a, b. The first cavity V₁ and the second cavity V₂ increase in axial direction as the mating of the pin and box progresses, as seen in FIGS. 21 and 22. FIG. 22 illustrates a mated state.

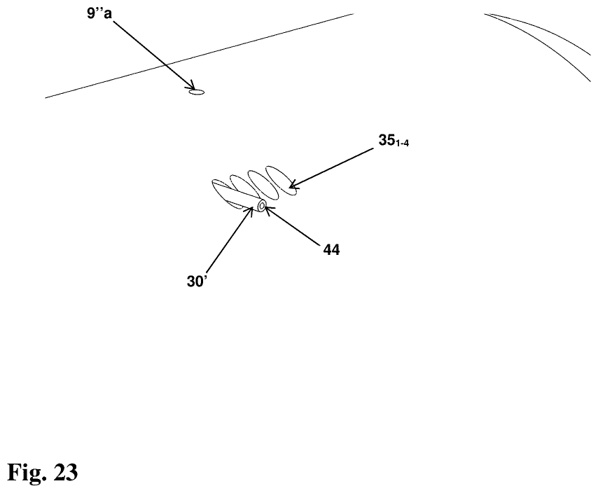

FIG. 23 illustrates an embodiment of the elongated locking member 30′having an axial bore 44. The axial bore may be used as a supply channel for fluid into the cavities formed between the pin and box, thus removing the need for a separate fluid port 9a; 9′a; 9″a.

It should be understood that embodiments described above may be combined, even though not every combination is illustrated in the figures.

Break-out is accomplished by applying a suitable liquid pressure through one (or more) of the conduits similarly to the procedure explained above, whereupon the pin may be released (and withdrawn) from the box.

The invented coupling assembly is preferably without conventional threads and therefore requires no rotation during connection or disconnection. The time required to connect and disconnect the coupling is therefore reduced significantly. By injecting the hydraulic fluid between the frusto-conical pin surface and box surface, elastic expansion of the box member and elastic compression of the pin member is accomplished, which enables a completion of the connection.

The invented coupling assembly will also allow the pipe joint cross-section to be reduced, as there is no need for traditional iron-roughneck, manual rig tongs or bucking units. On-site handling challenges are therefore mitigated.

The hydraulic friction coupling as described above will also allow drilling of significantly longer and deviated wellbores, as friction loss by circulating drilling fluid is reduced, and the torque capacity of the pipe joint is increased. The invented coupling assembly will also lower the sequence time (make or break) significantly and hence the cost of drilling.

1. A coupling assembly for elongated elements, comprising:
a pin member having an outward-facing pin surface, and a box member having an inward-facing box surface, said pin surface and box surface configured for mating engagement, wherein:
the coupling assembly comprises one or more elongated flexible locking member and in that:
the pin member comprises at least one first groove, the at least one first groove being circular and circumferential, non-helical;
the box member comprises a corresponding at least one second groove, the at least one second groove being_circular and circumferential, non-helical; and
the box member comprises at least one insertion port, aligned with the at least one second groove;
whereby, when a pin-and-box connection is made up, the first groove and the corresponding second groove are aligned and form a circular, non-helical, and circumferential channel shaped and dimensioned for receiving the elongated flexible locking member.

2. The coupling assembly of claim 1, wherein the circular grooves are arranged perpendicularly to a longitudinal axis of the box and pin.

3. The coupling assembly of claim 1, wherein material of the one or more elongated flexible locking member includes a higher strength than material of the box member and pin member.

4. The coupling assembly of claim 1, wherein the elongated flexible locking member (30) is a wire or flexible rod.

5. The coupling assembly of claim 1, wherein an at least one bore has a first opening configured for connection to an injection fluid reservoir and a second opening penetrating the pin surface or the box surface, whereby a fluid may be injected into a cavity formed between at least a portion of an outer pin surface and a corresponding inner box surface portion.

6. The coupling assembly of claim 5, wherein the pin member comprises an external circumferential seal groove and the box member comprises an internal circumferential seal groove, and wherein the grooves are configured and arranged for alignment when the pin-and-box connection is made up, and for receiving a seal.

7. The coupling assembly of claim 6, wherein the seal grooves are arranged such that they isolate the cavity from the channel formed by the at least one first groove and the at least one second groove when the pin-and-box connection is made up.

8. The coupling assembly of claim 1, wherein at least a first cavity is arranged on one side of the at least one channel and at least a second cavity is arranged on the other side of the at least one channel.

9. The coupling assembly of claim 8, wherein the first cavity and the second cavity are defined by respective portions of an outer surface of the pin member and an of the box member, and respective sets of seals.

10. The coupling assembly of claim 1, wherein the locking member further comprises a fastener element.

11. The coupling assembly of claim 1, wherein the box member comprises a slot in vicinity of the insertion port, the slot configured for receiving a fastener element.

12. The coupling assembly of claim 1, wherein length of the locking member length corresponds to circumference of the channel.

13. The coupling assembly of claim 1, wherein the pin surface comprises a plurality of pin protruding portions separated by pin recessed portions, and the box surface comprises a plurality of box protruding portions separated by box recessed portions; and wherein a pin protruding portion is shaped and dimensioned to fit into a designated box recessed portion, and wherein a box protruding portion is shaped and dimensioned to fit into a designated pin recessed portion.

14. The coupling assembly of claim 1, wherein the elongated flexible locking member comprises an axial bore, whereby a fluid may be injected into cavity or cavities formed between the pin and box surfaces.
